(19) United States
(12) Patent Application Publication
(10) Pub. No.: US 2005/0268327 A1
(43) Pub. Date: Dec. 1, 2005

(54) Enhanced electronic mail security system and method

(75) Inventor: Yuri A. Starikov, Redmond, WA (US)

Correspondence Address: DAVIS WRIGHT TREMAINE, LLP, 2600 CENTURY SQUARE, 1501 FOURTH AVENUE, SEATTLE, WA, 98101-1688, US

(73) Assignee: Secure Communications Technology, LLC, Kirkland, WA (US)

(21) Appl. No.: 11/125,850

(22) Filed: May 10, 2005

Related U.S. Application Data
(60) Provisional application No. 60/571,387, filed on May 14, 2004.
(60) Provisional application No. 60/571,559, filed on May 14, 2004.

(51) Int. Cl. H04L 9/00

(52) U.S. Cl. 726/1

(57) ABSTRACT

For purposes of patent searching the following description involves an enhanced system that has an e-mail client, policy module, a clear signer and a steganographer. A removable device includes a public key, a private key, and a policy portion. The policy module requires the policy portion for operation such as in decrypting e-mails. The e-mail client encrypts using the private key in conjunction with clear signing with the public key and/or using steganography to mask e-mails. Other validation features are described that can be used before decryption of e-mails occurs.

### CROSS REFERENCE TO RELATED APPLICATIONS

This application claims the benefit of Provisional Application Nos. 60/571,387 filed on May 14, 2004 and 60/571,559, filed on May 20, 2004.

### BACKGROUND OF THE INVENTION

1. Field of the Invention

The present invention is directed generally to security with electronic communication and, more particularly, to security related to electronic mail.

2. Description of the Related Art

The use of unsecured e-mail over the Internet has replaced to some degree the use of physical delivery of letters and other items with regular mail. Unsecured e-mail over the Internet, however, has drawbacks such as being vulnerable to eavesdropping and counterfeiting. Conventional secure e-mail has addressed many issues related to unsecured e-mail. For instance, secure e-mail can provide message origin authentication, message integrity, nonrepudiation of origin, and message confidentiality. Unfortunately, there remain security issues even with conventional secure e-mail.

### BRIEF DESCRIPTION OF THE SEVERAL VIEWS OF THE DRAWING(S)

FIG. 1 is a schematic diagram of an enhanced e-mail security system.

FIG. 2 is a flowchart depicting a method for received e-mail processing to be implemented by the enhanced e-mail security system of FIG. 1.

FIG. 3 is a flowchart depicting a method to implement a step shown in FIG. 2 to determine whether a certificate storage and a policy module are integrated.

FIG. 4 is a flowchart depicting a method for secure e-mail generation to be implemented by the enhanced e-mail security system of FIG. 1.

### DETAILED DESCRIPTION OF THE INVENTION

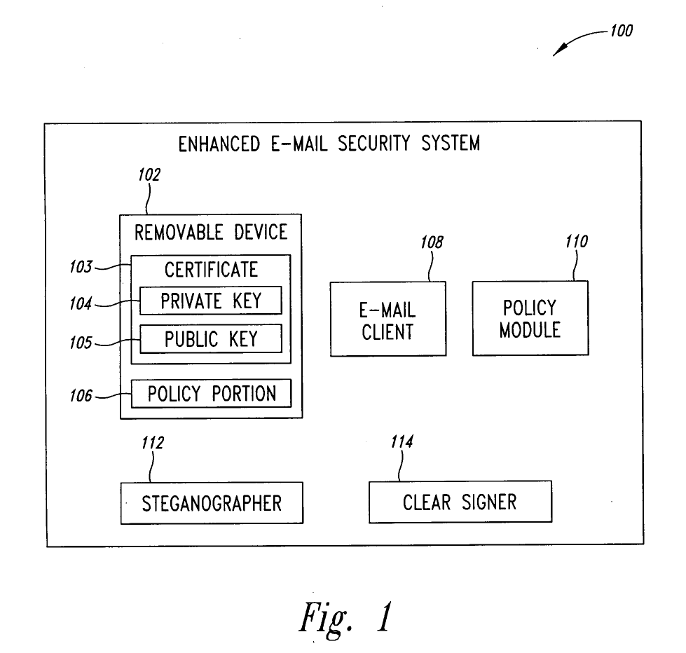

An enhanced electronic mail (e-mail) security system and method is disclosed herein that includes policy module integration and masked, sealed encryption. An exemplary implementation of an enhanced e-mail security system 100 is shown in FIG. 1 as including a removable device 102 with a certificate 103 that has a private key 104 and a public key 105. The enhanced system 100 further includes a policy portion 106, an e-mail client 108, a policy module 110, a steganographer 112, and a clear signer 114. The enhanced system 100 can be located on a computer system or other electronic system that can communicate via e-mail such as a pda, cell phone or other communication system.

The enhanced system 100 is configured to physically and/or electronically receive the removable device 102 so that in some implementations the removable device can be inserted into the enhanced system, otherwise physically linked or removed from the enhanced system typically by an end user and in other implementations the removable device can be otherwise electronically linked to the enhanced system. The removable device 102 in some implementations is a smart card being insertable into a conventionally known smart card reader (not shown). A smart card implementation of the removable device 102 could have a microcontroller with data storage or could solely have data storage. Other implementations use e-tokens, e-keys or other types of storage with or without microcontrollers for the removable device 102.

In general the removable device 102 contains the private key 104 either by storing the private key in a storage on the removable device or by generating the private key with the aid of a microcontroller contained in the removable device. The private key 104 generally is an identifier that is exclusive to the removable device 102 and serves to identify the removable device in a highly secure way and with a high degree of confidence. The private key 104 can take the form of a conventional private key associated with the public key 105 as found in asymmetric encryption methods in which the private key can be identified as such through use of conventional approaches involving the public key 105 and the certificate 103. In some implementations, the e-mail client 108 uses public key information contained on the public key 105 in the certificate 103, such as may be stored on or accessed by the policy module 110 to verify identity of the private key 104.

The removable device 102 also contains the policy portion 106, which is a portion of executable code or a separate independent executable that is necessary for execution or otherwise operation of the policy module 110. The policy portion 106 may be contained in storage in the removable device 102 or may be generated with an aid of a microcontroller as part of the removable device. The policy portion 106 runs either on an operating system of the removable device 102 or of the policy module 110. The policy portion 106 is integral with the policy module 110 such that without the policy portion 106, the policy module 110 is inoperable. Also, if the policy module 110 were to be somehow changed, the policy module would also be inoperable even if the policy portion 106 were available in the enhanced system 100.

The policy module 110 as implemented for Microsoft Outlook or Microsoft Outlook Express, 3COM Eudora, or other such e-mail systems can be a custom Windows data link library (DLL), which is designed for specific security management needs of an organization. The policy module 110 can have a program interface and be accessible for use by other programs. Through this program interface of the policy module 110, information can be obtained about access rights and security levels in related systems. Such information in the policy module 110 is tempting for unauthorized persons to access.

With conventional policy modules, unauthorized individuals can use “black box” methods to reveal the program interface, user's rights and other information available from the conventional policy modules. Other unauthorized actions associated with conventional policy modules can include use of information obtained from the conventional policy modules to construct replacements that may serve unauthorized purposes. The integration of the policy portion 106 and the policy module 110 in part seeks to hinder unauthorized acts associated with the policy module 110 that may otherwise be successfully used against conventional policy modules. Malicious attempts at tampering with, replacing, or outright theft of the policy module 110 by individuals that are not trusted enough to be issued a removable device 102 containing the policy portion 106 are hindered since the policy module 110 cannot be accessed without the policy portion 106 and any sorts of replacements of the policy module 110 cannot function in conjunction with the policy portion.

The e-mail client 108 can use various electronic mail security standards such as Secure Multipurpose Internet Mail Exchange (S/MIME) and Pretty Good Privacy (PGP) in the forms of PGP/MIME and a newer Open PGP standard. S/MIME and S/MME ESS are described by various documents such as Cryptographic Message Syntax (RFC 3369), Cryptographic Message Syntax (CMS) Algorithms (RFC 3370), Diffie-Hellman Key Agreement Method (RFC 2631), S/MME Version 3 Certificate Handling (RFC 2632), S/MME Version 3 Message Specification (RFC 2633), Enhanced Security Services for S/MIME (RC 2634).

In particular, S/MIME (Secure/Multipurpose Internet Mail Extensions) is a protocol that adds encryption and digital signatures to Internet MIME (Multipurpose Internet Mail Extensions) messages. MIME is a format for extended Internet electronic mail. Internet e-mail messages have a header and a body. The header is made up of structured information related to transmission of the message. The body is normally unstructured unless the e-mail is in MIME format, which standardizes enhanced text, graphics, audio, and other data content. Since MIME does not provide any security services, S/MIME defines services for digital signatures and encryption. Other electronic mail security standards can be used in implementations of the enhanced system 100 as well.

When the e-mail client 108 is implemented as an S/MIME client, it is configured to receive an encapsulated (encrypted) message, such as an S/MIME message having a security label. The security label contains information regarding the level of sensitivity of the message content or can be used for other purposes such as a source of routing information. Through authorization procedures, users are granted rights and/or privileges to permit certain access of information to the users. In some implementations the labels often describe ranked levels (“secret”, “confidential”, “restricted”, and so on) or are role-based, describing which kid of people can see the information (“patient's health-care team”, “medical billing agents”, “unrestricted”, and so on). Through access control procedures these authorizations are then enforced such as through use of the policy module 110.

The e-mail client 108 accesses client information contained on a public key certificate to ascertain authorization level granted to a particular user and accesses policy rules contained in the policy module 110 operating in conjunction with the policy portion 106 to determine when it is appropriate to decrypt the labeled message.

In some implementations of the enhanced system 100, at time of initialization, before activating its interface, the policy module 110 first verifies that the removable device 102 is present in the computer system or other system of the enhanced system and further verifies that the removable device 102 present is authorized to operate with the policy module. Furthermore, during execution, the policy module 110 runs an executable code, which can be either obtained from a storage on the removable device 102 or which must run on an operating system of a microcontroller on the removable device. As a consequence of these various security checks of the enhanced system 100, without an authorized version of the removable device 102 present in the enhanced system, the policy module 110 is not initialized and its program interface cannot be revealed to unauthorized individuals.

Disassembling the policy module 110 will not be a fruitful exercise either since executable code required for operating the policy module is in the removable device 102, which would not be available to unauthorized individuals, and therefore the policy module remains inoperable and unavailable to unauthorized individuals. Furthermore, since private keys are contained within the removable device and are not stored on a computer system or other such system having the enhanced system 100, there is reduced likelihood of the private keys being obtained by unauthorized individuals.

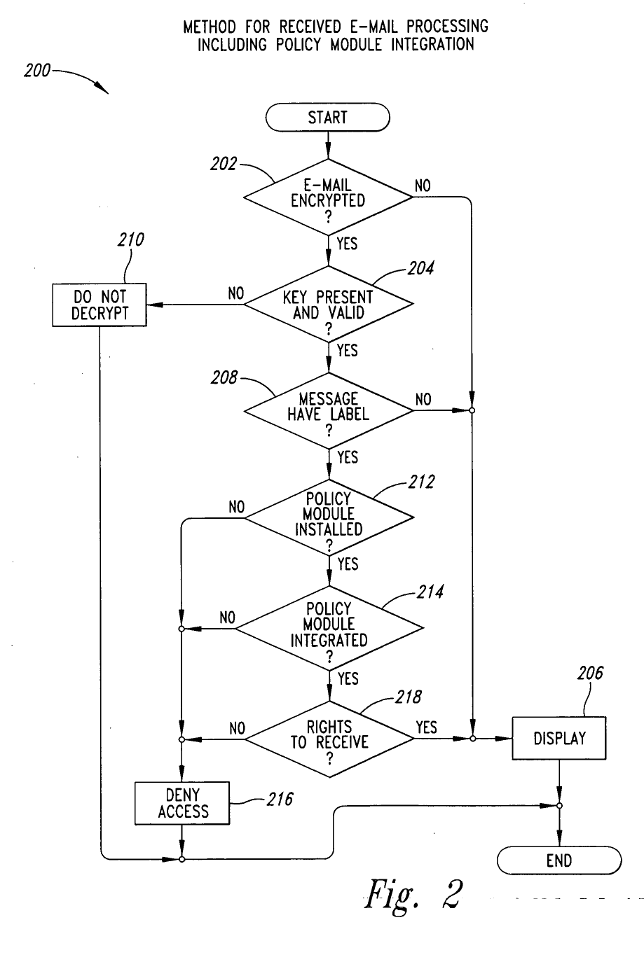

A method 200 as implemented by the enhanced system 100 for processing of a received e-mail in which the processing includes policy module integration is depicted in FIG. 2 as beginning by determining if the received e-mail is encrypted (decision step 202). If the received e-mail is encrypted, (YES branch of decision step 202), the method 200 branches to decision step 204. Otherwise (NO branch of decision step 202), the received message is displayed (step 206) and the method 200 ends. At decision step 204, if the private key of the removable device 102 is present and is verified as being valid, (YES branch of decision step 204), the method 200 branches to decision step 208. Otherwise (NO branch of decision step 204), the method 200 does not decrypt the received message (step 210) and the method ends. If the received message has a label (YES branch of decision step 208), the method 200 goes to decision step 212. Otherwise (NO branch of decision step 208), the received message is displayed (step 206) and the method ends.

If the policy module 110 is installed in the enhanced system 110 (YES branch of decision step 212), the method 200 goes to decision step 214. Otherwise (NO branch of decision step 212), access to the received message is denied (step 216) and the method 200 ends. If the policy module 110 is integrated with the removable device 102 (YES branch of decision step 214), the method 200 goes to decision step 218. Otherwise (NO branch of decision step 214), access is denied (step 216) and the method 200 ends. Based upon identification provided by the removable device 102, if the holder of the removable device is identified as being the recipient and has access rights to the received message (YES branch of decision step 218), the message is displayed (step 206) and the method 200 ends. Otherwise (NO branch of decision step 218), access is denied (step 216) and the method 200 ends.

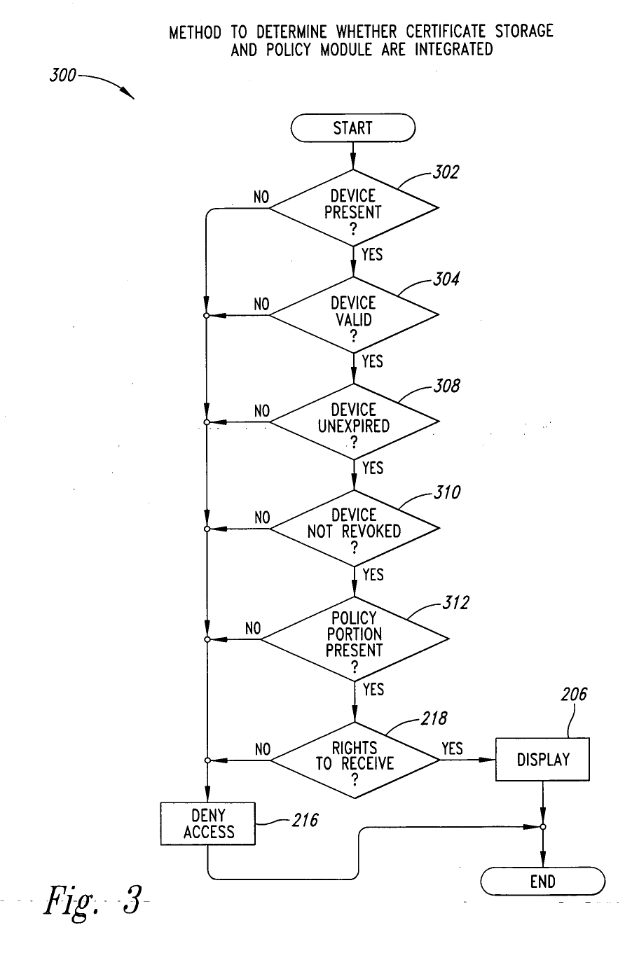

A method 300, depicted in FIG. 3 is implemented by the enhanced system 100 to carry out decision step 214 of method 200 to determine whether the policy module 110 is integrated with the removable device 102. If the removable device 102 is present in the enhanced system 100 (YES branch of decision step 302), the method 300 goes to decision step 304. Otherwise (NO branch of decision step 302), access to the received message is denied (step 216 of the method 200) and the method 300 ends.

If the removable device 102 has an identification indicating that it is from an authorized issuing organization and it is identified as being owned by the recipient as identified by the received e-mail the removable device is consider valid (YES branch of decision step 304), the method 300 goes to decision step 308. Otherwise, (NO branch of decision step 304), access is denied (step 216 of the method 200) and the method 300 ends. For decision step 304, the certificate 103 contained in the removable device 102 has the e-mail address of the owner of the removable device to allow for the e-mail address in the certificate to be compared with the recipient's e-mail address of the received e-mail to determinate whether the removable device is owned by the recipient of the received e-mail.

To determine whether the removable device 102 is from an authorized issuing organization, the decision step 304 checks if special secure data containing a secure code is present within the removable device 102, which was previously written into the removable device during the issuance process by the issuing organization. For instance, if the removable device is a Spyrus Rosetta smartcard or a universal serial bus (USB) token this special secure data is stored in a data file in a private area of the removable device. As another example, for the removable device 102 as a Spyrus LYNKS HSM, this special secure data in placed in a certificate slot. As another example, for the removable device 102 as an Athena smartcard, this special secure data is stored as private data. An algorithm provided by the hardware manufacture of the removable device 102 is typically used to access the special secure data.

If the removable device is determined not to be expired (YES branch of decision step 308), the method 300 goes to decision step 310. Otherwise (NO branch of decision step 308), access is denied (step 216 of the method 200) and the method 300 ends. To determine expiration status in decision step 308, an expiration date is stored in the certificate 103 of the removable device 102.

If the removable device 102 has not been revoked by its authorizing organization (YES branch of decision step 310), the method 300 goes to decision step 312. Otherwise (NO branch of decision step 310), access is denied (step 216 of the method 200) and the method 300 ends. The policy module 110 of the enhanced system 100 contains current revocation status of the removable devices 102, so is used in the decision step 310 to determine whether the removable device inserted into the enhanced system has been revoked.

If the policy portion 106 of the removable device 102 is present (YES branch of decision step 312), the method 300 ends. Otherwise (NO branch of decision step 312), access is denied (step 216 of the method 200) and the method 300 goes to the step 218 of the method 200 shown in FIG. 2.

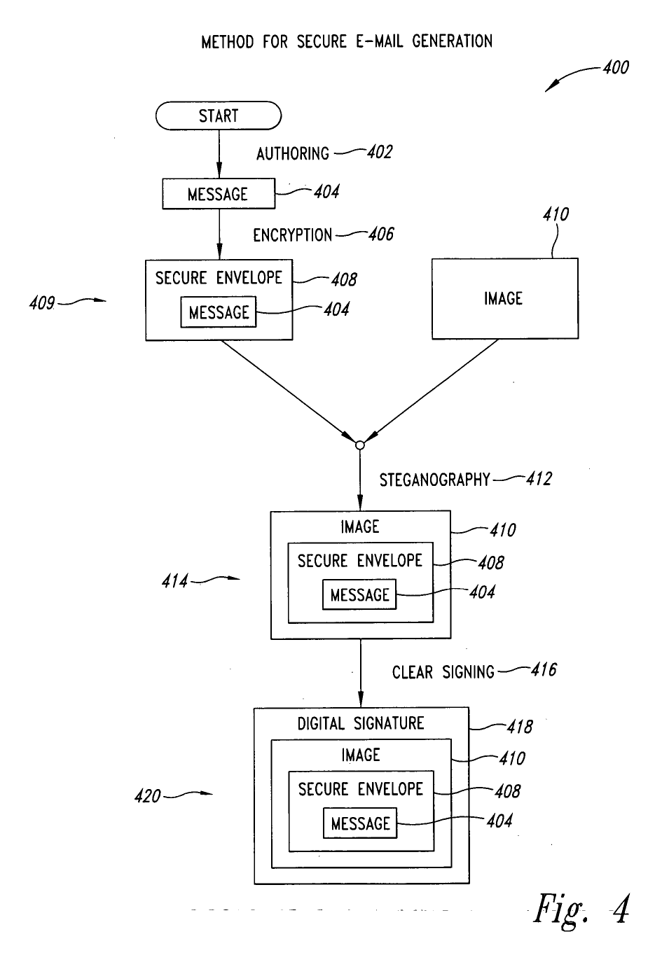

In generating and encrypting a message for transmission, the enhanced system 100 implements a method 400 depicted in FIG. 4 as starting by authoring (step 402) a message (404), which can contain text, graphics, and other types of formatted data. The message 404 is then encrypted (step 406) by encapsulating the message with a secure envelope 408 according to conventional encryption methods to produce an encrypted message 409. The encrypted message 409 tends to be rather secure, but it is relatively simple to identify in an e-mail stream and thus can raise interest by malicious persons and invite attack.

Steganography as conventionally applied is a method of hiding an unencrypted message within an image, such as a picture, by altering the data of the image in such a way as to contain the data of the unencrypted message while not noticeably altering the visual appearance of the finally rendered image. In the method 400, steganography (step 412) is used in an unconventional way to hide the encrypted message 409 in an image 410 to produce a steganoencrypted image 414. The steganography (step 412) adds camouflage to the encrypted message 409 so that the encrypted message appears less inviting of attack by malicious individuals. The encryption (step 406) also enhances the steganography (step 412) since even if the encrypted message 409 is discovered through unauthorized means its encryption presents a hurdle in addition to the camouflage of the stenagography to be overcome by those of malicious intent. By applying steganography (step 412) to the encrypted message 409 even if the encrypted message can be uncovered through conventional extraction methods the message remains encrypted.

The steganoencrypted image 414 is then clear signed (step 416) by the clear signer 114 using the public key 105 stored in the certificate 103 of the removable device 102 to add a digital signature 418 to the steganoencrypted image. Consequently, a masked, sealed encrypted message 420 is produced due to the steganography masking the appearance that the message 404 is encrypted and the added digital signature sealing the message to thereby provide a way to detect if the message has undergone unauthorized alteration, deletion, or substitution. The steganoencrypted image 414 without being clear signed still runs the risk that an unauthorized individual could discover the encrypted message 409 hidden within the image 410 and alter, delete, or replace the encrypted message without this unauthorized activity being detected by the intended recipient of the message 404. By adding the digital signature 418, any such unauthorized activity would be detected by discovering the alteration or deletion of the digital signature.

The foregoing detailed description has set forth various embodiments of the devices and/or processes via the use of block diagrams, flowcharts, and examples. Insofar as such block diagrams, flowcharts, and examples contain one or more functions and/or operations, it will be understood that each function and/or operation within such block diagrams, flowcharts, or examples can be implemented, individually and/or collectively, by a wide range of hardware, software, firmware, or virtually any combination thereof.

However, those skilled in the art will recognize that the embodiments disclosed herein, in whole or in part, can be equivalently implemented in standard Integrated Circuits, as one or more computer programs running on one or more computers (e.g., as one or more programs running on one or more computer systems), as one or more programs running on one or more controllers (e.g., microcontrollers), as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

In addition, those skilled in the art will appreciate that the mechanisms of the present invention are capable of being distributed as a program product in a variety of forms, and that an illustrative embodiment of the present invention applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory; and transmission type media such as digital and analogue communication links (e.g., packet links).

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A device comprising:
an electronic storage containing:
a private key configured for use with secure e-mail; and
a first executable code configured to operate with a second executable code, the second executable code configured to operate with the first executable code, the second executable code being contained within a policy module, the policy module located on a system configured to be used with the secure e-mail system, the storage configured to be electronically linked with the computer at least when the first executable code and the second executable code operate with each other.

2. The system of claim 1 wherein the electronic storage contains the private key in a certificate.

3. The system of claim 1 wherein the electronic storage further contains an e-mail address of a user associated with the private key.

4. The device of claim 1 wherein the electronic storage is configured to be physically inserted into the system before the first executable code operates with each other.

5. The system of claim 1 wherein first executable code is configured to run on the system in conjunction with the second executable code running on the system.

6. A first system comprising:
a second system including:
an e-mail client configured to receive encrypted e-mails; and
a policy module that includes security information and has an interface configured to link the policy module to the e-mail client based on a first condition that a policy portion is accessible to operate with the policy module, the policy portion not being included with the first system; and
a removable device configured to attach and detach from the second system, the removable device including the policy portion, the removable device configured to provide access to the policy module to operate with the policy portion when the removable device is attached to the second system.

7. The first system of claim 6 wherein the removable device includes an operating system and the policy portion is configured to run on the operating system of removable device.

8. The first system of claim 6 wherein the removable device is configured to attach and detach to the second system via a card reader.

9. The first system of claim 6 wherein the removable device is a smart card.

10. The first system of claim 6 wherein the policy portion is configured to run on the policy module.

11. The first system of claim 6 wherein the policy module is a portion of a data link library.

12. The first system of claim 6 wherein the removable device further contains a public key and wherein the e-mail client is configured to access the public key and to access the policy module when the policy module has access to operate with the policy portion to determine a security authorization granted a user associated with the removable device.

13. A first system comprising:
a second system including an e-mail client to encrypt e-mails, and a clear signer; and
a removable device having a public key, the removable device configured to be attachable and detachable from the second system, the clear signer configured to use the public key when the removable device is attached to second system to clear sign e-mails after they are encrypted by the e-mail client.

14. A first system comprising:
a second system including an e-mail client to originate e-mails, and a steganographer configured to mask the e-mails by steganography; and
a removable device containing a public key, the clear signer configured to use the public key when the removable device is attached to the second system to clear sign e-mails after they are encrypted by the e-mail client.

15. A first system comprising:
a second system including an e-mail client to encrypt e-mails, and a steganographer configured to mask the encrypted e-mails by steganography; and
a removable device having a public key, the clear signer configured to use the public key when the removable device is attached to the second system to clear sign encrypted e-mails after the encrypted e-mails have been masked by the steganographer.

16. A method comprising:
storing e-mail security information in a policy module located on a system;
linking a removable device to the system;
verifying that the removable device is authorized to operate with the policy module;
if the removable device is authorized to operate with the policy module, providing access to the policy module by an application on the system.

17. The method of claim 16 wherein access is provided to the policy module to an e-mail client as the application on the system.

18. The method of claim 16 wherein verifying that the removable device is authorized includes examining a public key contained on the removable device.

19. The method of claim 16 wherein verifying that the removable device is authorized by an organization includes verifying whether an identification associated with the organization is contained by the removable device.

20. The method of claim 16 wherein verifying that the removable device is authorized includes running a first code stored on the removable device in conjunction with a second code stored on the policy module.

21. The method of claim 16 wherein verifying that the removable device is authorized includes comparing an e-mail address stored on the removable device with an e-mail address associated with an e-mail received by the system.

22. The method of claim 16 wherein verifying that the removable device is authorized includes determining whether the removable device has been revoked by an issuing organization through indication by the policy module.

23. The method of claim 16 further comprising ascertaining authorization level granted to a particular user through a public key contained on the removable device and information contained in the policy module.

24. A method comprising:
encrypting an e-mail; and
clear signing the encrypted e-mail.

25. The method of claim 24 wherein the clear signing is performed on a system and uses a public key contained in a device removable from the system.

26. A method comprising:
applying steganography to an e-mail to generate a masked e-mail; and
clear signing the masked e-mail.

27. A method comprising:
encrypting an e-mail;
applying steganography to the encrypted e-mail to generate a masked encrypted e-mail; and
clear signing the masked encrypted e-mail.
